(19) United States
(12) Patent Application Publication
(10) Pub. No.: US 2004/0067290 A1
(43) Pub. Date: Apr. 8, 2004

(54) Display device cleaning system

(75) Inventors: Timothy D. Swofford, Mechanicsville, VA (US); Steve L. Rembisz, Midlothian, VA (US)

Correspondence Address: FOLEY & LARDNER, 777 EAST WISCONSIN AVENUE, SUITE 3800, MILWAUKEE, WI, 53202-5308, US

(73) Assignee: Delaware Capital Formation, Inc.

(21) Appl. No.: 10/265,892

(22) Filed: Oct. 7, 2002

(51) Int. Cl. A23K 1/00

(52) U.S. Cl. 426/335

(57) ABSTRACT

A display device is disclosed for at least one food-grade object and includes a display surface to display the food-grade object, at least one passage adapted for distributing a fluid within the display device, and an ozonated water source in communication with the passage. A system is also disclosed for cleaning and moisturizing a food item in a display device and includes a fluid distribution system to distribute a fluid in relation to the display device, an ozone source in communication with the fluid to selectively provide an ozonated fluid, an application device engaging the fluid distribution system to apply the ozonated fluid in communication with the food item.

### FIELD OF THE INVENTION

The present invention relates to a display device cleaning system. The present invention relates more particularly to a display device cleaning system with ozonation. The present invention relates more particularly to a display device with an ozonation system for cleaning, deodorizing, disinfecting and moisturizing food products and/or components of the display device.

### BACKGROUND

It is generally known to provide display devices for commercial or institutional food sales or food service facilities such as supermarkets, grocery stores, cafeterias, etc. These display devices may operate with refrigeration or cooling devices such as temperature controlled cases (individually or in groups), and may also include non-refrigerated display devices such as produce cases or ice tables for storing or displaying objects for advertising or sale to consumers. Such objects typically include food-grade objects such as produce, meat, fish, poultry, etc. in which the control, reduction or elimination of materials such as germs, viruses, molds, bacteria, fungus, pathogens, pesticides, herbicides, etc. is desirable or essential.

In such known display devices, passages and/or reservoirs are often provided for directing or containing fluids such as water, cleaning or disinfecting solutions, liquids emanating from displayed objects, or runoff from condensation and melted ice or frost. Such passages often include moisture application devices such as misters for maintaining the moisture content or humidity level of the objects being displayed. In typical misters having tube or hose passages for delivery of water, cleaning of the passages is typically difficult to accomplish, potentially resulting in contamination of the water being delivered to the misters and applied to the objects in the display device.

Although such passages and reservoirs may be provided with manual or automatic washing/flushing systems for cleaning and deodorizing the display device, cleaning of the passages and reservoirs is often difficult and has typically required removal of the objects and/or temporary shutdown of the display device to allow cleaning agents or solutions to be circulated through the passages and reservoirs and/or manual or automatic cleansing of the display device surfaces on a regular basis to maintain the cleanliness of the display device within acceptable industry standards or guidelines. Such cleaning operations often interrupt use of the display device for its intended purpose, may require additional time and manual labor, and may increase the potential that cleaning solutions or residue may come in contact with the objects.

Accordingly, it would be advantageous to provide a display device that may be easily and effectively cleaned, deodorized and disinfected. It would also be advantageous to provide a display device that may be cleaned, deodorized and disinfected without having to remove the displayed objects. It would further advantageous to provide a display device that may be cleaned and deodorized without removing the display device from service. It would also be advantageous to provide a display device having a moisture application system capable of cleaning, disinfecting, deodorizing and moisturizing the stored or displayed objects. It would be further advantageous to provide a display device having a cleaning, deodorizing, disinfecting and moisturizing agent or substance that is compatible with food-grade objects. It would be further advantageous to provide a display device having a cleaning, deodorizing, disinfecting and moisturizing agent or substance that is environmentally friendly.

Accordingly, it would be advantageous to provide a display device having any one or more of these or other advantageous features.

### BRIEF DESCRIPTION OF THE DRAWINGS

FIG. 1 is a flow diagram of a display device according to a preferred embodiment.

FIG. 2 is a perspective view of a display device according to a preferred embodiment.

FIG. 3 is side elevation view of another display device according to a preferred embodiment.

FIG. 4 is a flow diagram of several display devices according to another preferred embodiment.

### SUMMARY

The present invention relates to a display device for at least one food-grade object and includes a display surface adapted to display the food-grade object, at least one passage adapted for distributing a fluid within the display device, and an ozonated water source in communication with the passage.

The present invention also relates to a system for cleaning and moisturizing a food item in a display device and includes a fluid distribution system configured to distribute a fluid in relation to the display device, an ozone source in communication with the fluid to selectively provide an ozonated fluid, an application device operably engaging the fluid distribution system and adapted to apply the ozonated fluid in communication with the food item.

The present invention further relates to a method of cleaning a display device and cleaning and moisturizing a plurality of food objects displayed therein, and includes providing a display surface adapted to display the plurality of food objects in the display device, providing a fluid passage network for distributing a fluid to one or more of the display device and the plurality of food objects, providing a food-compatible cleaning agent in communication with the fluid, distributing the fluid to one or more of the display device and the plurality of food objects in a first mode, and distributing the fluid and the food-compatible cleaning agent to one or more of the display device and the plurality of food objects in a second mode.

The present invention further relates to a cleaning device for a display case and a plurality of food products displayed therein and includes means for distributing a fluid in communication with one or more areas in the display case to be cleaned, means for distributing the fluid in communication with the plurality of food products, and means for selectively introducing a food-compatible cleaning agent to the fluid for distribution in communication with one or more of the areas in the display case to be cleaned and the food products.

The present invention further relates to a method of improving the appearance and shelf life of food items in a display case and includes providing a fluid distribution system in communication with the display device for delivering a fluid from a supply source to the food items, providing an additive from an additive supply source in communication with the fluid distribution system, selectively mixing the additive with the fluid; and providing an application device configured to disperse the additive and fluid in a wetting relationship with the food items.

### DETAILED DESCRIPTION OF THE PREFERRED EMBODIMENTS

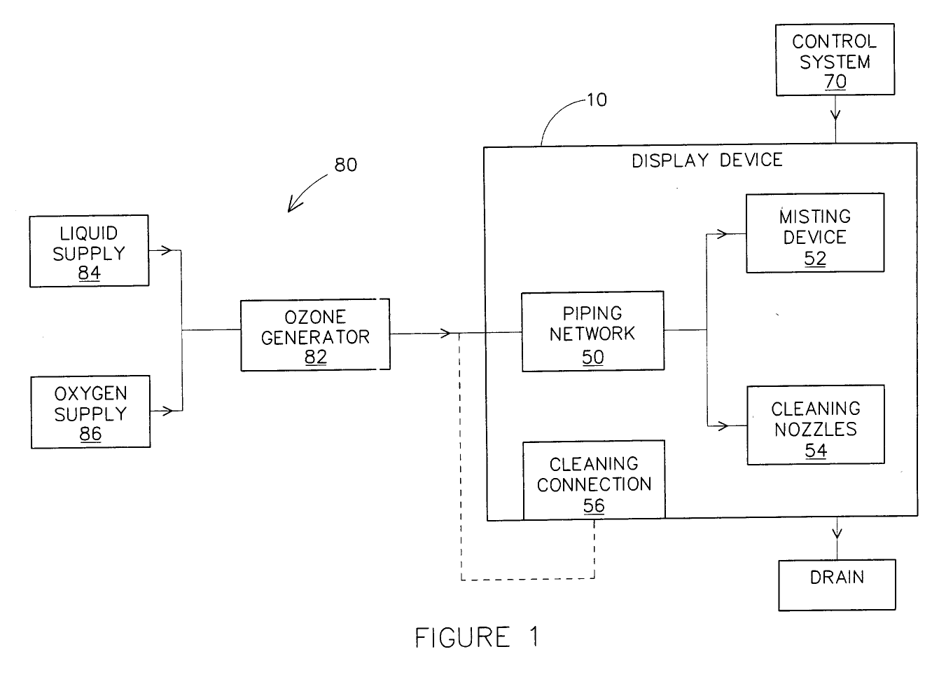

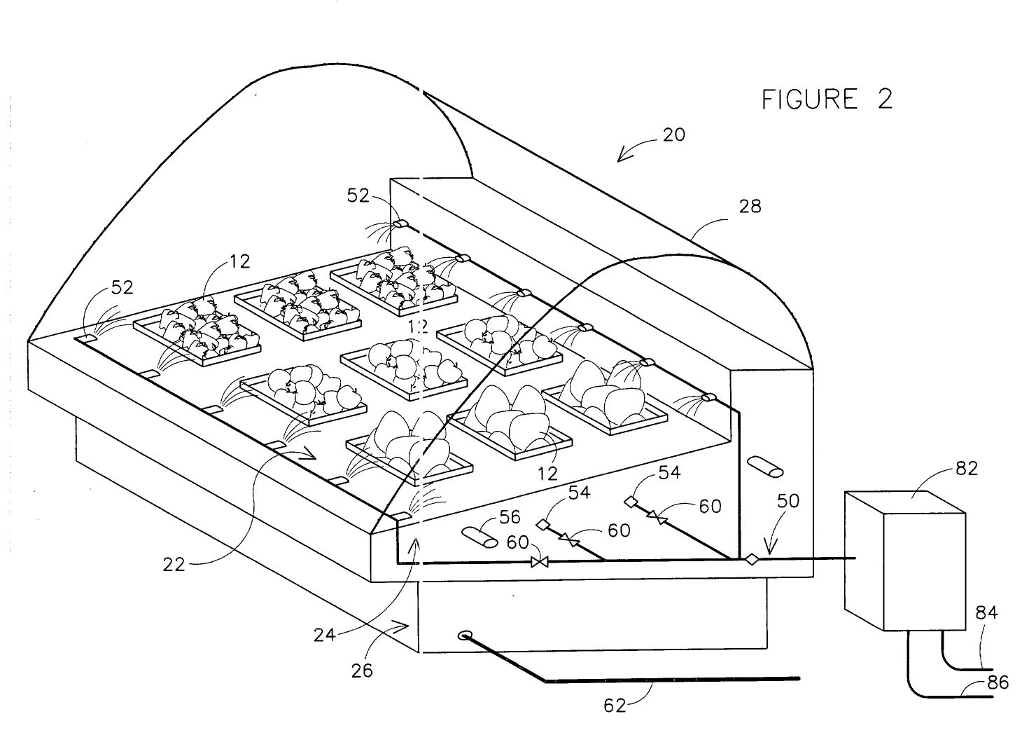

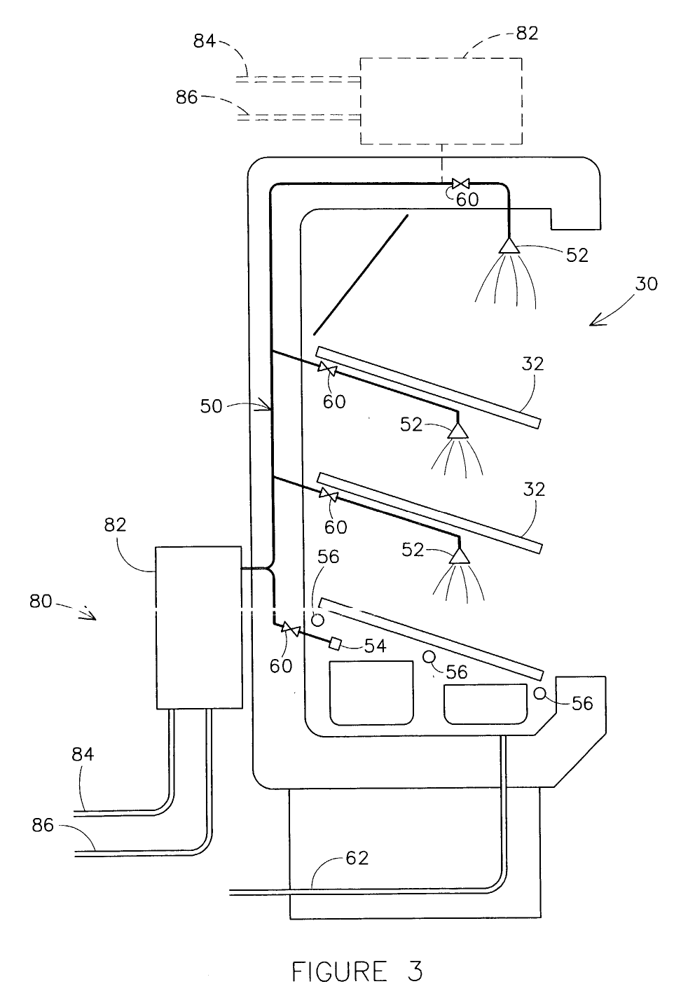

Referring to FIG. 1, a display device is shown schematically according to a preferred embodiment. Display device 10 may be a temperature controlled display device (e.g. refrigerated unit, cooler, ice table, etc.) or a non-temperature controlled display device (e.g. non-refrigerated unit, etc.). Display device 10 may be in the form of a case, merchandiser, stand, or other display device for storing or displaying objects (shown schematically as food products 12 in FIGS. 2-3) in a facility such as a supermarket, kitchen, cafeteria, deli, restaurants, etc. The display device 10 may be an open-type display device such as those typically used for displaying produce, and may be a closed-type display device such as those typically used for displaying meat or other food products. The display device 10 interfaces with a fluid supply system 80 for moisturizing and/or cleaning (e.g. disinfecting, deodorizing, decontaminating, etc.) the components of the display device 10 (i.e. display device shelves, parts, passages, piping, tubing, reservoirs, etc.) and/or the food products 12 stored or displayed in the display device 10. The display device includes a piping system or piping network 50 for receiving a fluid such as a cleaning agent or substance from the fluid supply system 80 and distributing the fluid for moisturizing and cleaning within the display device 10. According to a particularly preferred embodiment, the piping network 50 interfaces with a plurality of fluid application devices (e.g. nozzles, sprayers, etc.—shown schematically as misting devices or misters 52). Misters 52 are configured to deliver a mist or spray of the fluid on or over the food products 12 within the display device 10. The piping network 50 may also be connected to cleaning devices, shown schematically as nozzles or sprayers 54 for cleaning the interior of the display device 10. The display device 10 may also include an external connection 56 (such as among others a fitting or quick-disconnect) for connecting an external supply of the fluid for cleaning the components of the display device. According to an alternative embodiment, the display device may be any device configured for the display of food products or other objects for which contamination control or cleaning is desirable. According to another alternative embodiment, the piping network may be any suitable network of tubing or other conduit located internal or external to the display device for routing the fluid to the desired locations.

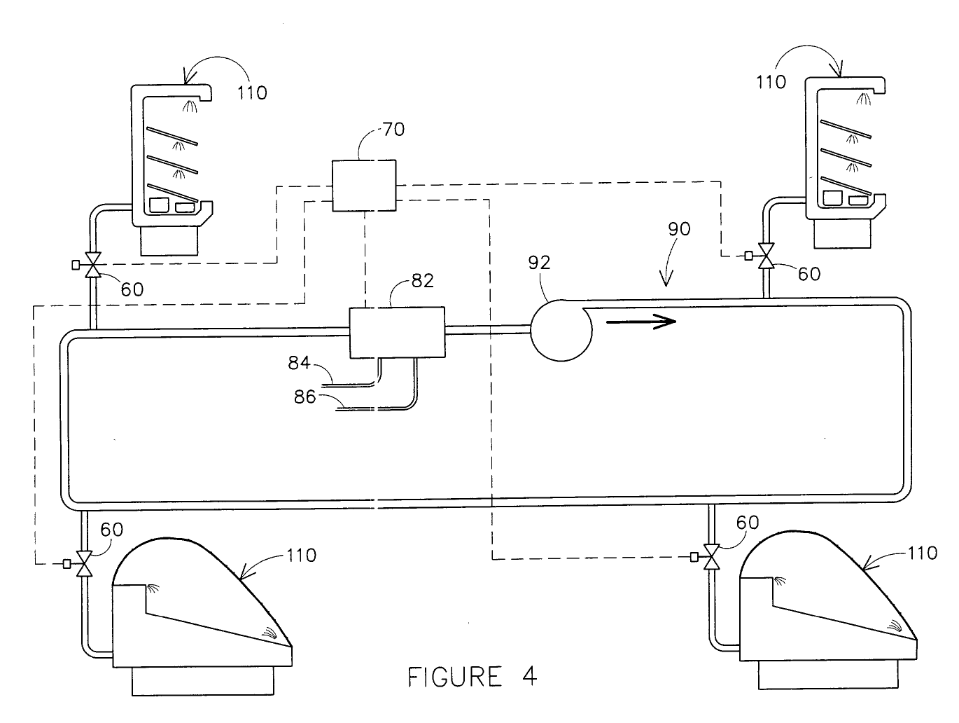

Referring further to FIG. 1, a fluid supply system 80 is shown according to a preferred embodiment. Fluid supply system 80 interfaces with the piping network 50 and/or the connection(s) 56 to provide the fluid used for cleaning the display device 10 and/or moisturizing the food products 12. Fluid supply system 80 includes a cleaning agent supply device for providing a cleaning agent for use with the fluid supply. According to a particularly preferred embodiment, the cleaning agent supply device is an ozone generator 82 and the cleaning agent is ozone. Ozone generator 82 is configured to receive a supply of liquid (shown schematically as a liquid supply 84) (e.g. water from a municipal water supply, building distribution system, potable water supply line, etc.). Ozone generator 82 is also configured to receive a supply of oxygen (shown schematically as an oxygen supply 86) (e.g. ambient facility air, compressed oxygen tank, etc.) for converting the liquid supply 84 and the oxygen supply 86 into a moisturizing and cleaning fluid (e.g. ozonated water, etc.) for use in moisturizing and cleaning the food products 12 and/or the components of the display device 10. The ozone generator may be a conventional ozone generating device for converting oxygen and water into ozonated water at sufficient ozone concentrations within allowable regulatory limitations for use in cleaning the food products and the display device components. In general, for fluids with a lower ozone concentration, a longer time duration of the fluid in contact with the food products or display device components is required to accomplish the desired cleaning. For fluids with a higher ozone concentration, a shorter time duration of the fluid in contact with the food products or display device components is required. The ozone generator may be associated with a single display device (as shown in FIGS. 2 and 3) or may be associated with multiple display devices (as shown in FIG. 4). The ozone generator may be provided as an integral part of a new display device or may be provided as a retrofit application for use with one or more display devices within the facility.

Referring further to FIG. 1, the display device 10 interfaces with a control system 70. Control system 70 may be a conventional control system that provides the appropriate controls for operating the ozone generator 82 and/or the display device 10, and may be associated with the operation of a single display device, or may be configured to control the operation of multiple display devices. Control system 70 is adapted to receive a signal for controlling (among others parameters) the concentration of ozone in the fluid and for controlling the flow control devices (shown schematically as valves 60 in FIGS. 2-4). Valves 60 are configured for delivering the fluid within the display device 10. According to an alternative embodiment, the concentration of ozone within the fluid and distribution of the fluid within the display device may be controlled manually, such as by manual adjustment of valves, manual operation of the ozone generator, etc.

Referring to FIG. 2, display device 20 is shown according to a preferred embodiment. Display device 20 is shown as a temperature controlled, closed-type merchandiser having a display platform 22 that is supported above an equipment area 24 that is positioned on a base 26. According to a particularly preferred embodiment, display platform 22 is shown completely enclosed by a cover 28 (e.g. canopy, hood, etc.). Display platform 22 is configured to support food products 12 in a visible and accessible manner for marketing food products 12 in a controlled environment that helps to prolong the shelf life of food products 12. The application of moisture from the fluid to the food products tends to improve the appearance and help to minimize the loss of moisture from the food products. The infusion or introduction of a food-compatible cleaning agent into the fluid for moisturizing the food products also helps to preserve the cleanliness of the food product by helping to remove or disinfect and deodorize any contaminants such as germs, viruses, molds, bacteria, fungus, pathogens, herbicides, pesticides, etc. that may be present. The infusion or introduction of a food-compatible cleaning agent into the fluid also may be used for cleaning the display case components as the fluid is routed or directed in contact with the display device components. According to an alternative embodiment, the display platform may be partially enclosed by a cover or other suitable structure.

Referring further to FIG. 2, the fluid supply system 80 may be coordinated with liquid supply 84 and oxygen supply 86 (which may be an existing water supply and an existing air or oxygen supply within the facility). According to a particularly preferred embodiment, the amount of ozone infused or introduced into the liquid by the ozone generator 82 is a sufficient amount to disinfect contaminants in liquid supply 84 and contaminants associated with food products 12 and the components of the display device 20 depending on the desired contact time of the fluid with food products 12 and the components of the display device 20. The fluid from the fluid supply system 80 is directed within the display device 10 by piping network 50. According to a particularly preferred embodiment, piping network 50 includes one or more misters 52 located within the display device 20 and configured to direct the fluid in a desired pattern (e.g. spray, mist, etc.) on or over the food products 12. The misters 52 may be provided at any suitable location to provide the desired distribution pattern for the fluid (shown schematically as located at a front side and a rear side of the display platform). The piping network 50 also includes internal cleaning devices shown as sprayers or nozzles 54 for cleaning the components in the display device. Nozzles 54 are preferably positioned to distribute the fluid in a desired distribution pattern over the surfaces of the components of the display device (e.g. drainage receptacles, basins or troughs (not shown), the display platform, and other surfaces or components) that are susceptible to contamination from the food products, operation of the display device, or external contamination sources.

Referring further to FIG. 2, the piping network 50 may be provided with one or more flow control devices (e.g. valves, etc.—shown as solenoid operated valves 60) for directing the flow of the fluid to the desired location within the display device 20 and may be controlled manually or automatically by the control system 70. According to another preferred embodiment, the display device 20 may have connections 56 (such as fittings, quick-disconnects, etc.) located at various positions on the display device 20 and adapted to deliver the fluid to the components of the display device via an external device, such as a hose or portable cleaning station (not shown). The display device 20 includes a drain 62 or other suitable structure for removing drainage and used fluid from the display device 20. According to a preferred embodiment, ozone generator 82 is shown schematically located at the rear of the display device 20. According to an alternative embodiment, the ozone generator may be located beneath the display device, within the base of the display device, or remotely from the display device (see FIG. 4).

Referring to FIG. 3, a display device 30 is shown according to another front type display device that may be refrigerated or non-refrigerated. Display device 30 includes one or more display platforms 32 for displaying food objects in a stacked or vertical or partially-vertical configuration. The fluid from the fluid supply system 80 is directed within the display device 30 by piping network 50. According to a particularly preferred embodiment, piping network 50 includes one or misters 52 located within the display device 30 and configured to direct the fluid in a desired distribution pattern (e.g. spray, mist, etc.) over the food products. The misters 52 may be provided at any suitable location to provide the desired distribution pattern for the fluid (shown schematically as located above each display platform 32). The piping network also includes internal cleaning devices shown as sprayers or nozzles 54 for cleaning the internal components of the display device 30. Nozzles 54 are preferably positioned to distribute the fluid in a desired pattern over the surfaces of the components of the display device (e.g. drainage receptacles, basins or troughs (not shown), the platform(s), and other surfaces or components) that are susceptible to contamination from the food products, operation of the display device, or external contamination sources.

Referring further to FIG. 3, the piping network 50 may be provided with one or more flow control devices (shown as solenoid operated valves 60) for directing the flow of the fluid to the desired location within the display device 30 and may be controlled manually or automatically by the control system 70. According to another preferred embodiment, the display device 30 may have connections 56 (such as fittings, quick-disconnects, etc.) located at various positions on the display device 30 and adapted to deliver the fluid to the components of the display device via an external device, such as a hose (not shown). The display device 30 includes a drain 62 or other suitable structure for removing drainage and used fluid from the display device 30. As further shown in FIG. 3 the ozone generator 82 may be located at the rear of the display device 30, above the display device 30 (shown schematically in broken lines), or remotely from the display device 30 (see FIG. 4). According to an alternative embodiment, the flow control devices may be manual valves or balance valves or other suitable device for controlling, directing or regulating the delivery of the fluid to the display devices or to the misters or nozzles within the display device.

Referring to FIG. 4, the display device cleaning system is shown according to another preferred embodiment. Several display devices 110 (shown schematically as four but may be any number suitable for use in a facility) may be provided in facilities such as supermarkets, etc. In such applications where several display devices 110 are provided, a central fluid supply system 90 may be provided. Central fluid supply system 90 is provided in a recirculating configuration (e.g. loop, circuit, etc.) and includes a cleaning agent supply device (shown schematically as an ozone generator 82). Ozone generator 82 receives a liquid supply 84 (e.g. water from a municipal water supply, etc.) and an oxygen supply 86 (e.g. ambient facility air, compressed oxygen storage tank, etc.) for converting liquid supply 84 and oxygen supply 86 into a fluid (e.g. ozonated water, etc.) for use in moisturizing and cleaning the food products and/or the components of the display device. Liquid supply 84 provides an initial source of liquid for filling central fluid supply system 90 and a source of make-up liquid for replenishment as the fluid is distributed from central fluid supply system 90 to display devices 110. A pump 92 is provided to circulate the fluid throughout central fluid supply system 90 for delivery to display devices 110. The capacity of central fluid supply system 90 and pump 92 are sized to provide the desired quantity of fluid to the display devices 110 based on the number of display devices 110 and the fluid demand for each display device 110. Flow control devices (shown as solenoid operated valves 60) are provided for directing the flow of the fluid to the desired display devices 110 and may be controlled manually or automatically by the control system 70. Ozone generator 82 or central fluid supply system 90 includes one or more sensors (not shown) configured to provide a signal 94 representative of the concentration of the ozone in the fluid to control system 70. The control system 70 controls the operation of the ozone generator 82 to maintain the desired concentration of ozone within the fluid. According to an alternative embodiment, the flow control devices may be located at or within each display device and controlled by a single control system for a corresponding display device or a central system common to several display devices.

According to any preferred embodiment, the display device cleaning system provides a system for cleaning and/or moisturizing food products in a display device and for cleaning the components of a display device with a food compatible cleaning agent. The display device cleaning system is intended for use with any type of display device (open, closed, refrigerated, non-refrigerated, etc.) for food products or other objects for which contamination control or removal is desirable.

It is important to note that the construction and arrangement of the elements of the display device cleaning system provided herein are illustrative only. Although only a few exemplary embodiments of the present invention have been described in detail in this disclosure, those skilled in the art who review this disclosure will readily appreciate that many modifications are possible in these embodiments (such as variations in features such as fluid distribution patterns, fluid flow configurations, valve types and control configurations, ozone concentrations, location of ozone generators, new or retrofit applications, liquid types, sensors, etc.) without materially departing from the novel teachings and advantages of the invention. Further, it is readily apparent that variations of the display device cleaning system and its components and elements may be provided in a wide variety of types, shapes, sizes and performance characteristics, or provided in locations external or partially external to the display device. Accordingly, all such modifications are intended to be within the scope of the inventions.

The order or sequence of any process or method steps may be varied or re-sequenced according to alternative embodiments. In the claims, any means-plus-function clause is intended to cover the structures described herein as performing the recited function and not only structural equivalents but also equivalent structures. Other substitutions, modifications, changes and omissions may be made in the design, operating configuration and arrangement of the preferred and other exemplary embodiments without departing from the spirit of the inventions as expressed in the appended claims.

What is claimed is:

1. A display device for at least one food-grade object, comprising:
a display surface adapted to display the food-grade object;
at least one passage adapted for distributing a fluid within the display device; and
an ozonated water source in communication with the passage.

2. The display device of claim 1, wherein the fluid is an ozonated water.

3. The display device of claim 2, wherein the passage includes at least one mister for applying the ozonated water to the food-grade object.

4. The display device of claim 3, wherein the food-grade object is at least one of a meat object and a produce object.

5. The display device of claim 1, wherein the passage communicates with at least one component of the display device to be cleaned.

6. The of display device of claim 5, wherein the fluid is an ozonated water and further comprising a control system adapted to selectively distribute the ozonated water to the component of the display device to be cleaned.

7. The display device of claim 6, wherein the control system is an automatic control system.

8. The display device of claim 6, wherein the control system is a manual control system.

9. The display device of claim 1, wherein the ozonated water source is in communication with a plurality of display devices.

10. The display device of claim 1, wherein the passage is a flushing system adapted to clean the display device.

11. The display device of claim 1, wherein the passage includes a quick-connect member adapted to receive the ozonated water source.

12. The display device of claim 1, wherein the display device is a temperature controlled case.

13. The display device of claim 1, wherein the display device is an existing display device and the ozonated water source is a modular source adapted for use with the display device as a retrofit application.

14. A system for cleaning and moisturizing a food item in a display device, comprising:
a fluid distribution system configured to distribute a fluid in relation to the display device;
an ozone source in communication with the fluid to selectively provide an ozonated fluid;
an application device operably engaging the fluid distribution system and adapted to apply the ozonated fluid in communication with the food item.

15. The system of claim 14, wherein the food item is a perishable item and the display device is a temperature controlled merchandiser.

16. The system of claim 14, wherein the food item is a produce item and the display device is a produce display.

17. The system of claim 14, wherein the application device is a mister adapted to provide an ozonated fluid mist on the food item.

18. The system of claim 14, Wherein the fluid further comprises water.

19. A method of cleaning a display device and cleaning and moisturizing a plurality of food objects displayed therein, comprising:
providing a display surface adapted to display the plurality of food objects in the display device;
providing a fluid passage network for distributing a fluid to one or more of the display device and the plurality of food objects;
providing a food-compatible cleaning agent in communication with the fluid;
distributing the fluid to one or more of the display device and the plurality of food objects in a first mode; and
distributing the fluid and the food-compatible cleaning agent to one or more of the display device and the plurality of food objects in a second mode.

20. The method of claim 19, wherein the fluid comprises water.

21. The method of claim 19, wherein the food-compatible cleaning agent comprises ozone.

22. The method of claim 19, further comprising providing an ozone generator in communication with the fluid passage network.

23. The method of claim 19, wherein the first mode is a moisturizing mode and the second mode is a cleaning mode.

24. A cleaning device for a display case and a plurality of food products displayed therein, comprising;
means for distributing a fluid in communication with one or more areas in the display case to be cleaned;
means for distributing the fluid in communication with the plurality of food products; and
means for selectively introducing a food-compatible cleaning agent to the fluid for distribution in communication with one or more of the areas in the display case to be cleaned and the food products.

25. The cleaning device of claim 24, wherein the fluid comprises water.

26. The cleaning device of claim 24, wherein the food-compatible cleaning agent is ozone.

27. The cleaning device of claim 24, further comprising means for retrofitting the display device to receive a modular food-compatible cleaning agent supply source.

28. A method of improving the appearance and shelf life of food items in a display case, comprising:
providing a fluid distribution system in communication with the display device for delivering a fluid from a supply source to the food items;
providing an additive from an additive supply source in communication with the fluid distribution system;
selectively mixing the additive with the fluid; and
providing an application device configured to disperse the additive and fluid in a wetting relationship with the food items.

29. The method of claim 28, wherein the additive has one or more of the properties of a disinfectant, a fungicide, and a germicide.

30. The method of claim 28, wherein the fluid comprises water and the additive comprises ozone.

31. The method of claim 28, wherein the food items are produce items.
